(19) United States
(12) Patent Application Publication
(10) Pub. No.: US 2013/0332199 A1
(43) Pub. Date: Dec. 12, 2013

(54) SYSTEMS AND METHODS FOR CONSUMER-DRIVEN MOBILE HEALTHCARE PAYMENTS

(71) Applicants: Hanny Freiwat, Portland, OR (US); Shawn J. Smith, Portland, OR (US)

(72) Inventors: Hanny Freiwat, Portland, OR (US); Shawn J. Smith, Portland, OR (US)

(73) Assignee: CAMBIA HEALTH SOLUTIONS, INC., Portland, OR (US)

(21) Appl. No.: 13/490,233

(22) Filed: Jun. 6, 2012

(51) Int. Cl. G06Q 30/06; G06Q 40/08

(52) U.S. Cl. 705/4; 705/26.41

(57) ABSTRACT

Consumer-driven healthcare payments are made to providers of healthcare services. A healthcare payment system receives, from a mobile device associated with a consumer of healthcare services, an identification of a selected provider of the healthcare services. The system identifies a price list for one or more healthcare services offered by the provider and transmits the identified price list to the mobile device. The system receives a payment request from the mobile device. The payment request identifies at least one service selected from the price list and one or more funding sources. The system transfers electronic payment for the selected service from the one or more funding sources to an account associated with the selected provider. The one or more funding sources may include a bank account, a health savings account (HSA), a health insurance plan, a credit card, a debit card, and/or an electronic payment service.

### TECHNICAL FIELD

The present disclosure relates to healthcare payments. More particularly, the present disclosure relates to systems and methods for providing consumer-driven healthcare payments to providers of healthcare services.

### BACKGROUND

It is estimated that healthcare providers allocate about 25% to 40% of their service prices to operational costs associated with claims processing. Typically, when a consumer of healthcare services visits a healthcare provider, an administrative employee checks-in the consumer and validates insurance eligibility, if applicable, using an electronic data interchange (EDI) transaction according to guidelines provided by the Health Insurance Portability and Accountability Act (HIPAA) (e.g., an “EDI 270/271” transaction). The healthcare provider (e.g., doctor) sees the consumer (e.g., patient) and prepares a paper or electronic “super bill,” which describes the diagnosis found and procedures performed. After the consumer leaves the provider's office, the super bill is either sent to a medical coder who transcribes the provider's notes and adds diagnosis coding or entered into an electronic medical records (EMR) system. The EMR system or the coder sends the coded bill to provider billing, which submits an electronic claim (e.g., using an “EDI 837” transaction) to the consumer's health insurance company. The health insurance company adjudicates the claim and returns electronic remittance advice (e.g., using an “EDI 835” transaction) along with a related electronic funds transfer (EFT) payment. The electronic remittance advice instructs the provider as to what portion of the payment should be billed to the consumer. The consumer receives an explanation of benefits (EOB) from the health insurance company and one or more billing notifications from the provider. The consumer may pay the provider 60 days to 90 days later. Super bill coding, billing services, and the extensive delay in receiving payment from health insurance companies and consumers adds substantial costs to provider operations.

Certain consumers of healthcare services desire greater control over their healthcare budgets and have turned to “consumer-driven” healthcare policies or plans. In a consumer-driven plan, a high-deductible health plan is generally used to protect the consumer from catastrophic medical expenses. High-deductible plans cost less and the user pays routine medical claims using a pre-funded spending account, often with a special debit card provided by a bank or insurance plan. The account may include, for example, a health savings account (HSA), a health reimbursement account (HRA), or similar medical payment product. If the balance on this account runs out, the consumer may use another form of payment (e.g., cash or credit card) to pay claims. Consumers keep any unused balance or “rollover” at the end of the year to increase future balances, or to invest for future expenses. However, because healthcare costs are generally not transparent and historic details of the health plan (e.g., amount remaining in the high-deductible or amount available in the consumer's HSA account) may not be readily available to the consumer, it may be difficult for many consumers to decide which services to purchase and how to structure payments for such services.

HSA claims processing may also be administratively cumbersome. The process generally requires the health plan to manually input individual receipts for each member. This can create a backlog of claims in the later part of the year as members who are close to reaching their deductible send in their receipts. Further, some healthcare providers currently operate outside of the health plan's contractual reporting obligations. This non-compliance means that healthcare providers accept cash payments from patients but do not report encounters to the health plan. Without this reporting, HSA members need to submit a paper receipt to the health plan in order for their cash payments to be applied toward their deductible and out-of-pocket maximums. This creates not only an expense for the health plan to process receipts manually, but also requires the member to retain and submit receipts.

### SUMMARY

Systems and methods are disclosed for providing consumer-driven healthcare payments to providers of healthcare services. A healthcare payment system receives, from a mobile device associated with a consumer of healthcare services, an identification of a selected provider of the healthcare services. The system identifies a price list for one or more healthcare services offered by the provider and transmits the identified price list to the mobile device. The system receives a payment request from the mobile device. The payment request identifies at least one service selected from the price list and one or more funding sources. The system transfers electronic payment for the selected service from the one or more funding sources to an account associated with the selected provider.

Additional aspects and advantages will be apparent from the following detailed description of preferred embodiments, which proceeds with reference to the accompanying drawings.

### BRIEF DESCRIPTION OF THE DRAWINGS

The various embodiments will now be described in more detail, by way of example only, with reference to the accompanying drawings, in which:

FIGS. 1A and 1B are simplified block diagrams of a mobile device in communication with a healthcare payment system according to certain embodiments;

FIG. 2 is a block diagram illustrating use of the mobile device shown in FIGS. 1A and 1B during a visit to a provider according to an example embodiment;

FIG. 3 is a block diagram illustrating functions performed by the mobile device and the healthcare payment system according to one embodiment;

FIG. 4 is a flowchart of a method performed by the healthcare payment system to make healthcare payments according to one embodiment;

FIG. 5 is a block diagram illustrating a system architecture according to one embodiment; and

FIG. 6 is a flowchart of a method performed by mobile application of the mobile device to make healthcare payments according to one embodiment.

### DETAILED DESCRIPTION OF PREFERRED EMBODIMENTS

In certain embodiments, a mobile application (e.g., for a smartphone or other mobile communication device) provides personalized information to a consumer (e.g., patient) regarding services and related costs of a selected provider (e.g., doctor), and allows the consumer to directly pay for the services. The payments may be drawn from, for example, a health savings account (HSA), an insurance plan, a credit card, a debit card, a bank account, an electronic payment service (e.g., PayPal™), a combination of the foregoing, or other accounts. The mobile application may provide authorization and instructions to the consumer's bank or HSA account to transfer funds to the health care provider.

In addition, or in other embodiments, the mobile application interfaces with the consumer's health insurance company to coordinate eligibility, pricing, and real time adjudication of services. Thus, the mobile application can provide the consumer with data that is useful for deciding between different payment options (e.g., paying cash for the total amount or billing at least a portion to the insurance plan), and provides information to the insurance company to update the patient's deductible.

The mobile application may be part of a revenue cycle management system that enables doctors to receive point-of-sale cash payments directly from patients. The system offers an efficient claims and payment platform for use with HSAs or other medical payment products. The system enables providers to offer automated clearing house (ACH) and/or electronic funds transfer (EFT) “direct” payment prices for HSA members or other consumers at a discount to already negotiated managed care contract pricing. The discount may be available due to the elimination or reduction of the administrative burden associated with claim submissions for the provider and health insurance company.

HSA members or uninsured consumers have generally relied upon the providers' discretion to offer a cash pay discount to avoid insurance administration costs, but many HSA members still request the provider to bill their health plan to ensure that the claim and subsequent payment are correctly applied to their out-of-pocket maximum and deductible. This billing process is administratively inefficient and defeats the providers' intent to offer a cash price to consumers without insurance.

Thus, certain embodiments disclosed herein substantially reduce or eliminate the providers' administrative burden by providing direct payments that are equivalent to cash and HSA debit card payments. The provider has little or no interaction with the health insurance company or the payment system from the time that the consumer arrives at the provider's office through receipt of payment and the end of the transaction. In addition, the disclosed system captures claims data and sends a clean claim to the health plan, thereby fulfilling the contractual reporting obligation between the provider and the health insurance company. Some embodiments may allow a provider to submit a list of available services and associated prices (which may be agreed to and submitted through a health insurance company). But, unlike other systems that require the provider to use and drive the billing and payment process, the systems and methods disclosed herein are consumer driven and require little or no action on the part of the healthcare provider.

The embodiments of the disclosure will be best understood by reference to the drawings, wherein like elements are designated by like numerals throughout. In the following description, numerous specific details are provided for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed, as would be apparent to those skilled in the art. Thus, any order in the drawings or detailed description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a machine-readable medium having stored thereon instructions that may be used to program a computer (or other electronic device) to perform the processes described herein. The machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/computer-readable, non-transitory medium suitable for storing electronic instructions.

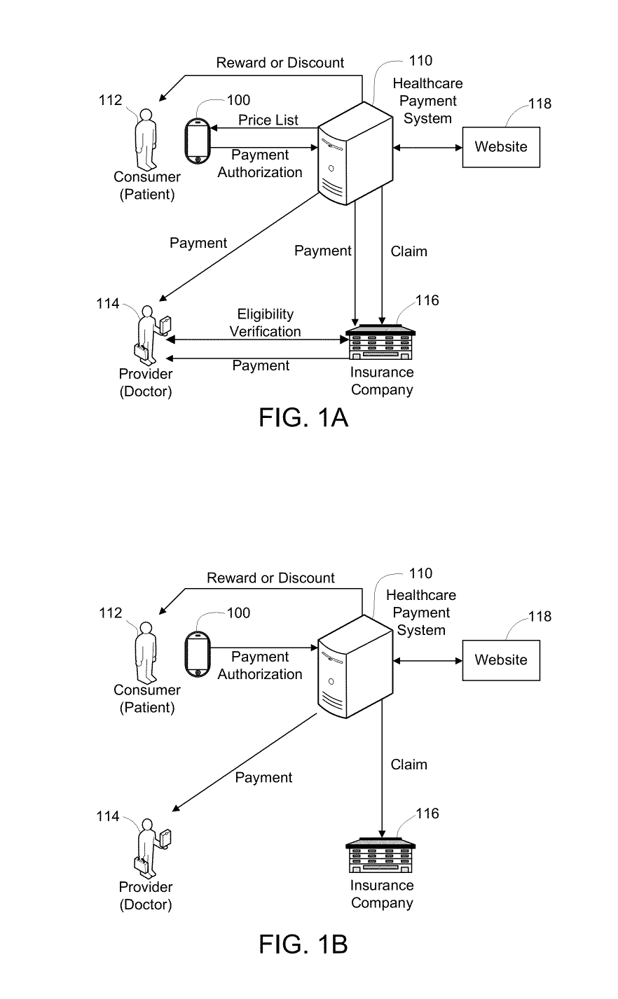

FIGS. 1A and 1B are simplified block diagrams of a mobile device 100 in communication with a healthcare payment system 110 according to certain embodiments. The mobile device 100 may comprise, for example, a smartphone or other mobile computing device configured to communicate with the healthcare payment system 110. The mobile device 100 includes a mobile application (not shown) configured to perform the functions disclosed herein. The mobile application associates a consumer 112 (e.g., patient) with the mobile device 100.

As shown in FIG. 1A, the mobile device 100 may receive a price list from the healthcare payment system 110. The price list may be associated with a selected provider 114 (e.g., doctor, pharmacist, physical therapist, or other medical professional). In other embodiments, the price list may be associated with a group of providers and/or an insurance company 116. For example, the price list may be associated with all providers that accept a certain health plan provided by the insurance company 116. The price list may include a plurality of services offered by the selected provider 114 and a price for each service that the provider agrees to accept on condition that direct payment is made through the healthcare payment system 110. In certain embodiments, the price list includes prices only for those services offered by the selected provider 114. In other embodiments, the price list includes prices for any service offered by a group of providers, even if a particular service is not offered by the selected provider 114. The price list may, for example, be based on an insurance contracted rate, a discounted rate based on the insurance contracted rate, and a cash price for the service. In certain embodiments, the consumer is allowed to override any price included in the price list (e.g., by negotiating with a provider to reduce her or his rate). In addition, or in other embodiments, the prices in the price list are equal to or lower than a price for a service as contracted or negotiated between the service provider and the insurance company. Thus, for insured consumers, the price list may include a contracted price list based on a verification of the consumer's insurance eligibility information. For uninsured consumers (or for consumers who choose not to declare that they have insurance), the price list may include the lowest rate offered by the provider and/or may inform the consumer of what others have paid for similar services to help them negotiate a better rate, if possible. As discussed below, the prices in the price list may allow for a reward or additional discount provided to the consumer 112 as an incentive for making direct payments to the provider 114 using the mobile device 100 and healthcare payment system 110.

In the embodiment shown in FIG. 1A, the selected provider 114 may have a contractual agreement with, or otherwise interact with, the insurance company 116. For example, the provider 114 may have agreed to the insurance company's price list or the provider 114 may have submitted her or his own price list to the insurance company 116. In certain embodiments, the provider 114 undergoes an initial registration process, either through the insurance company 116 or through a website 118 hosted by the healthcare payment system 110, to provide contact information, payment deposit information, the price list, and an indication of willingness to accept payments through the healthcare payment system 110. In certain embodiments, the website 118 may be branded so as to appear to be hosted by the insurance company 116. However, after the initial registration process, it is not necessary for the provider 114 to send information to or interact with the healthcare payment system 110 in order to receive direct payments.

When the consumer 112 arrives at the provider's office to receive healthcare services, the selected provider 114 may interact with the insurance company 116 in an eligibility verification process (e.g., an EDI 270/271 transaction). The consumer 112 may then select one or more services from the price list and the mobile device 100 may transmit payment authorization to the healthcare payment system 110. In response, the healthcare system 110 may make a direct payment to the selected provider 114 (e.g., through an ACH/EFT transfer to the provider's bank account). The payment may be from one or more sources including, for example, an HSA account, a health insurance plan, a bank account, a credit card, a debit card, an electronic payment service (e.g., PayPal™), or other account. In addition, or in other embodiments, a portion or all of the payment may be provided through the insurance company 116 to the selected provider 114 based on existing contractual arrangements. At some point during the transaction, the healthcare payment system 110 submits a claim (e.g., an “EDI 837” transaction) to the insurance company 116 to track the consumer's deductible, out-of-pocket maximums, and other information. This also satisfies the provider's obligation to submit the claim information.

In other embodiments, the selected provider 114 does not have a contractual agreement with, or otherwise interact with, the insurance company 116. In FIG. 1B, for example, the provider 114 does not participate in an eligibility verification process or receive payments from the insurance company 116. In this embodiment, the mobile device 100 also does not receive a price list from the healthcare payment system 110. In such embodiments, the consumer may manually enter in (type) a description of the service, select the service from a generic list, enter a code associated with the service, or scan a barcode or quick response (QR) code using the mobile application. The code, barcode, and/or QR code may be provided by the provider 114 at the time of service. Thus, the mobile application operating on the mobile device 100 may be used as an effective cash payment for healthcare services with little or no interaction between the provider 114, the insurance company 116, or the healthcare payment system 110. In certain embodiments where there is no interaction between the provider 114 and the insurance company 116, the provider 114 may undergo the initial registration process described above using the website 118, and may provide the price list shown in FIG. 1A.

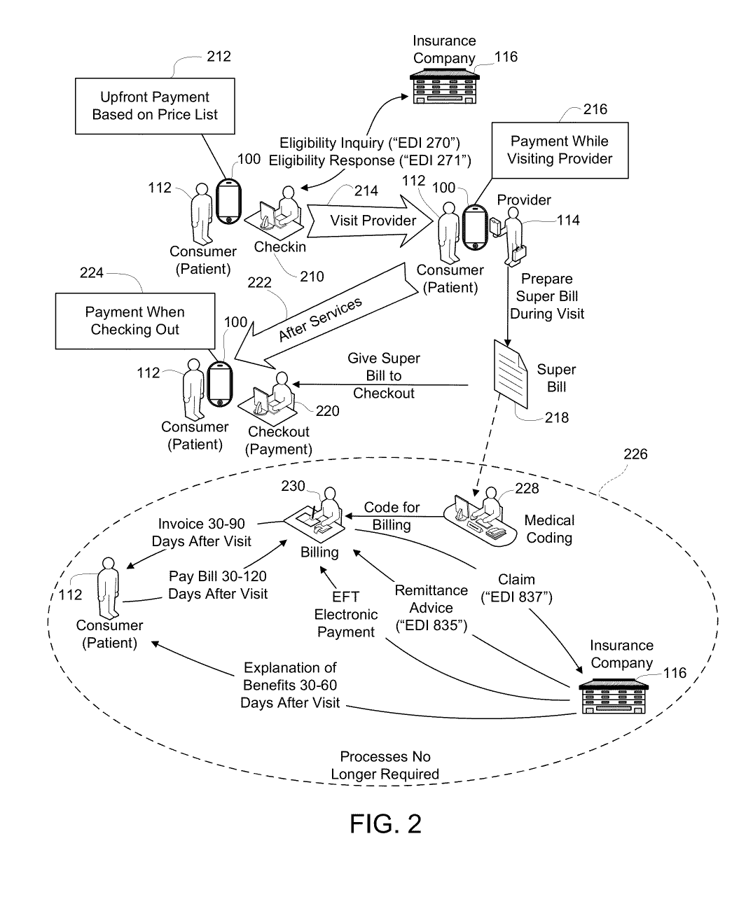

FIG. 2 is a block diagram illustrating use of the mobile device 100 shown in FIGS. 1A and 1B during a visit to a provider 114 according to an example embodiment. The mobile application operating on the mobile device 100 simplifies the interaction between the consumer 112 and the provider 114. The consumer 112 uses the mobile application to create a relationship with (or define parameters for interacting with) the insurance company 116, the provider 114, the consumer's bank, an HSA bank, a credit card, and/or a debit card. As shown in FIG. 2, the consumer 112 can then use the mobile device 100 to immediately pay the provider 114 at any time during the visit.

For example, at check-in 210, the consumer 112 may choose the service they expect to receive and use the mobile device 100 to make an upfront payment 212 based on the price list. Before providing services, particularly where upfront payment has not been made and/or additional expenses are expected, the provider may perform a standard eligibility enquiry (e.g., an “EDI 270” transaction) and receive an eligibility response (e.g., an “EDI 271” transaction). While visiting 214 the provider 114, the consumer 112 may use the mobile device 100 to immediately pay for services based on the provider 114 noting the services performed. As discussed above, the consumer 112 may manually enter in a description of the service, select the service from a list (including the price list), enter a code associated with the service, or scan a barcode or QR code using the mobile application. During the visit, the provider 114 may also prepare a super bill 218, which the provider 114 then gives to checkout 220. After 222 receiving the services from the provider 114, the consumer 112 may pay 224 for some or all of the services at checkout 220 (depending on which services, if any, were previously paid). At each step 212, 216, 224, the consumer 112 can rationalize services suggested and choose to engage the services with a full understanding of cost and value.

The mobile application enables the consumer 112 to have a mobile and personal healthcare data collection and payment terminal. This is highly differentiated from prior systems where providers and insurers attempt to integrate practice management systems with insurer claim systems to create real time adjudication on a point to point basis, which increases cost and complexity. By way of contrast with prior systems, FIG. 2 illustrates processes enclosed within a dashed line 226 that are no longer required as a result of certain embodiments disclosed herein. As shown, some of the eliminated processes include medical coding 228 to code the super bill 218 for the provider's billing 230, submission of the claim (e.g., an “EDI 837” transaction) by the provider's billing 230 to the insurance company 116, receipt and processing of remittance advice (e.g., an “EDI 835” process) from the insurance company 116, receipt of an EFT electronic payment from the insurance company 116, submission of an invoice at about 30 days to 90 days after the visit from the provider's billing 230 to the consumer 112, an explanation of benefits from the insurance company 116 to the consumer 112 at about 30 days to 60 days after the visit, and receipt of the bill payment from the consumer 112 to the provider's billing 230 at about 30 days to 120 days after the visit.

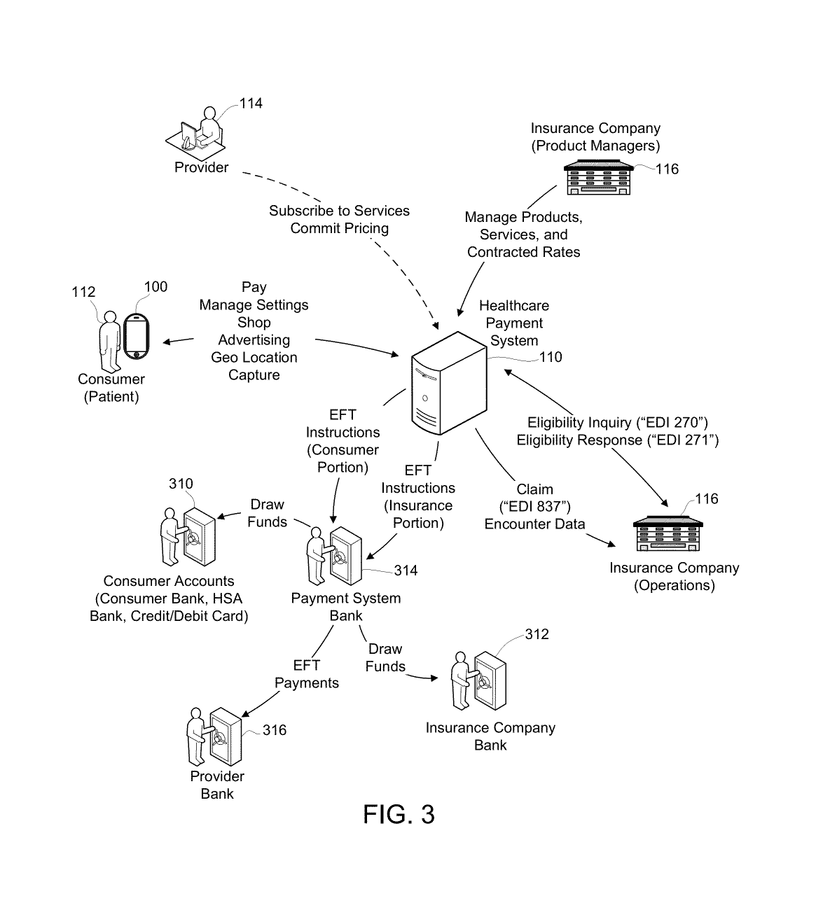

FIG. 3 is a block diagram illustrating functions performed by the mobile device 100 and the healthcare payment system 110 according to one embodiment. In addition to paying for healthcare services, the mobile device 100 may also allow the consumer 112 to manage settings (e.g., contact information, dependent information, insurance information, account information, user payment preferences, and other settings), shop (e.g., search for a new healthcare provider or specific services), receive advertising (e.g., directed advertising related to healthcare providers, services, or products), use geographic location services (e.g., to reduce fraud by verifying that the mobile device is in the vicinity of the provider's office when the authorization for payment is made), and/or capture claim data (e.g., for reporting to the insurance company 116).

As discussed above, in certain embodiments, the healthcare payment system 110 may allow the provider 114 to subscribe to a list of services and commit to pricing for those services. In an initial registration process, the provider 114 may access the healthcare payment system 110 through a website (see website 118 in FIGS. 1A and 1B). In other embodiments, the provider 114 may subscribe to services and commit to pricing through the insurance company 116. In certain embodiments, the healthcare payment system 110 allows certain users associated with the insurance company (e.g., product managers) to manage products, services, and contracted rates through the website.

The mobile application operating on the mobile device 100 communicates with the healthcare payment system 110 to coordinate pricing and/or adjudication of services. If the consumer 112 decides to pay cash, the interaction is relatively simple (e.g., the consumer pays 100% of the price in the price list). If the consumer 112 has an insurance plan (e.g., a preferred provider organization (PPO) and/or an HSA), then the healthcare payment system 110 retrieves current eligibility and/or deductible information from the insurance company 116 (e.g., using “EDI 270” and “EDI 271” transactions), computes the consumer's payment responsibility, and submits encounter data to the insurance company to update the consumer's deductible (e.g., using an “EDI 837” transaction).

The healthcare payment system 110 then submits appropriate payment advice to the consumer's accounts 310 and the insurance company's bank 312 to stage payment of funds to the provider 114. The consumer's accounts 310 may include, for example, the consumer's bank, an HSA bank, a credit card, a debit card, an electronic payment service (e.g., PayPal™), a combination of the foregoing, or other accounts. As shown in FIG. 3, the payment advice may include first EFT instructions corresponding to the consumer's portion of the payment submitted to the payment system's bank 314 for drawing funds from one or more of the consumer's accounts 310. The payment advice may also include second EFT instructions corresponding to the insurance portion of the payment submitted to the payment system's bank 314 for drawing funds from the insurance company's bank 312. In certain embodiments, the payment system's bank 314 retains a service fee from the funds drawn from the insurance company's bank 312 as revenue. The EFT instructions from the healthcare payment system 110 also include instructions for the payment system's bank 314 to submit EFT payments to the provider's bank 316.

The mobile application on the mobile device 100 and the healthcare payment system 110 allow for accelerated payment direct to the provider 114 from the consumer 112 and the insurance company 116. The consumer 112 has immediate cost information. The collection of statistical data on consumer/provider interaction allows for usage of that data to suggest continued service and other treatment/provider interactions.

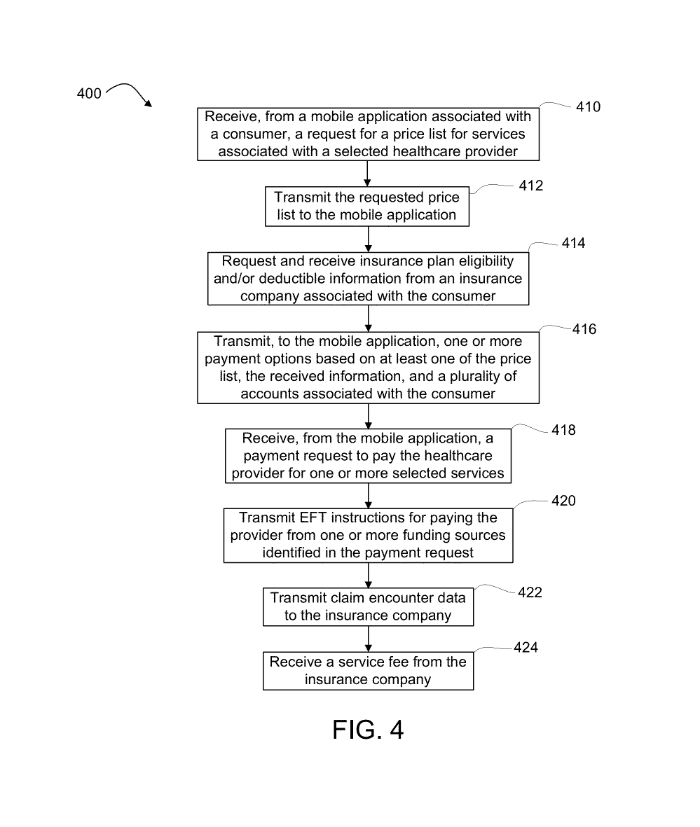

FIG. 4 is a flowchart of a method 400 performed by the healthcare payment system 110 to make healthcare payments according to one embodiment. The method 400 includes receiving 410, from a mobile application associated with a consumer, a request for a price list for services associated with a selected healthcare provider. The method 400 also includes transmitting 412 the requested price list to the mobile application, and requesting and receiving 414 insurance plan eligibility and/or deductible information from an insurance company associated with the consumer.

In certain embodiments, the method 400 further includes transmitting 416, to the mobile application, one or more payment options based on at least one of the price list, the received information, and a plurality of accounts associated with the consumer. For example, the healthcare payment system 110 may provide a plurality of different prices available to the consumer 112 based on whether the consumer 112 decides to pay all cash (e.g., a transfer from a bank account or HSA account), pay with a credit card, or pay a portion from an insurance plan (e.g., PPO) where a deductible has not been met.

The method 400 also includes receiving 418, from the mobile application, a payment request to pay the healthcare provider for one or more selected services, transmitting 420 EFT instructions for paying the provider from one or more funding sources identified in the payment request, transmitting 422 claim encounter data to the insurance company, and receiving 424 a service fee from the insurance company.

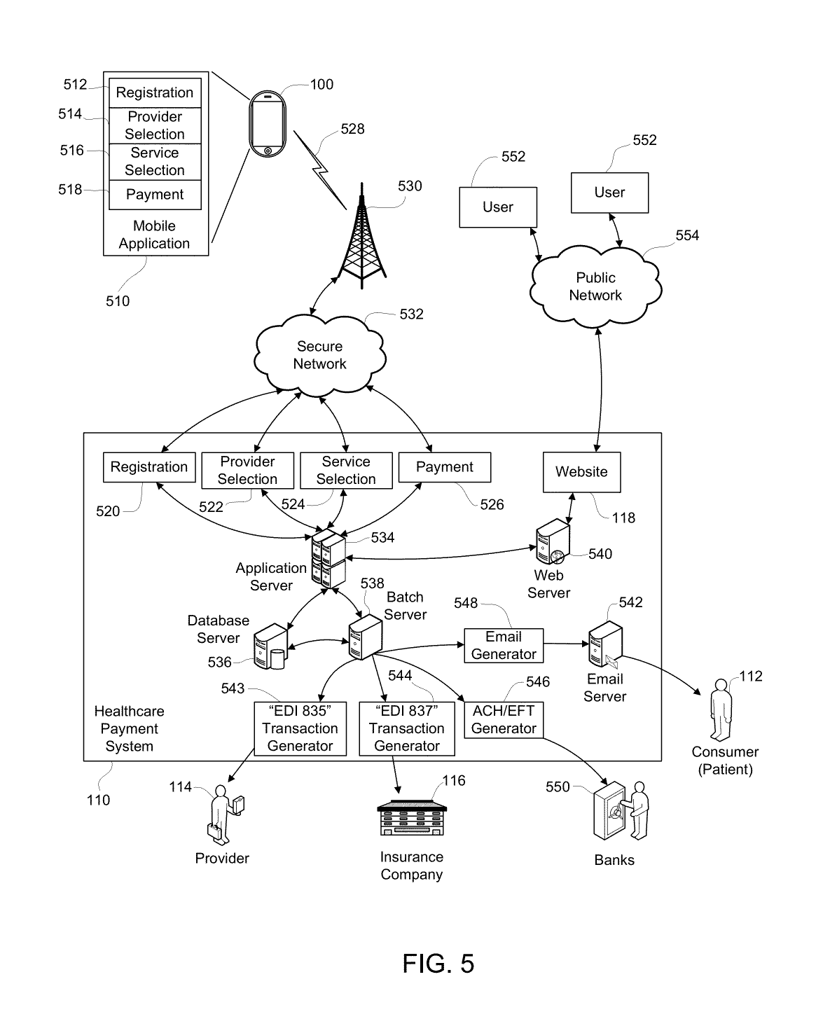

FIG. 5 is a block diagram illustrating a system architecture according to one embodiment. As shown in FIG. 5, an example mobile application 510 operating on the mobile device 100 includes a registration module 512, a provider selection module 514, a service selection module 516, and a payment module. Similarly, the healthcare payment system 110 includes a registration module 520, a provider selection module 522, a service selection module 524, and a payment module 526. Each of the modules 512, 514, 516, 518 of the mobile application 510 cooperates with the respective module 520, 522, 524, 526 in the healthcare payment system 110 to perform the functions described herein.

The mobile device 100 is configured to communicate with the healthcare payment system 110 through a wireless communication link 528, a cellular antenna 530, and secure network 532. The wireless communication link 528 and cellular antenna 530 may be part of a cellular telecommunications network configured for wireless communication of high-speed data for mobile phones and data terminals (e.g., 3G and 4G networks). The secure network 532 may include, for example, a local area network (LAN), a wide area network (WAN), a virtual private network (VPN), or other network configured to prevent and monitor unauthorized access, misuse, modification, or denial of network resources.

The healthcare payment system 110 may include a plurality of servers including an application server 534, a database server 536, a batch server 538, a web server 540, and an email server 542. Persons skilled in the art will recognize, however, that two or more of the servers may be combined into a single server, and that some embodiments may include additional servers (e.g., a text message server). The application server 534 provides the mobile application 510 with an interface to the healthcare payment system 110 through the registration module 520, provider selection module 522, service selection module 524, and payment module 526.

The registration module 512 of the mobile application 510 may display a graphical user interface on the mobile device 100 to prompt the consumer 112 to enter a user name and password. The registration module 512 also allows the consumer 112 to enter user information (e.g., name, date of birth, and contact information for the consumer and any of the consumer's dependents), account information (e.g., bank account information, HSA account information, credit card information, debit card information, and/or electronic payment service information), user preferences for accessing the different accounts in a particular order, provider information, and insurance plan information). The registration module 520 of the application server 534 verifies that all necessary registration information is received and creates an account for the consumer 112. The received information is stored by the database server 536.

The provider selection module 514 of the mobile application 510 may display a graphical user interface on the mobile device 100 to allow the consumer 112 to select a provider for a particular office visit and/or to identify a new provider. For a new provider, the provider selection module 514 may allow the consumer to scan a business card (e.g., having a QR code) of a new provider using the mobile device 100 to capture the provider's identification information, search for nearby providers (based on the mobile device's geographic location data), search for all providers who are pre-registered with the healthcare payment system 110, or receive suggestions for a new provider based on user preferences and current medical needs.

After the provider selection module 522 of the application server 534 receives an indication of a currently selected provider, the service selection module 524 of the application server 534 provides a price list of available services to the service selection module 516 of the mobile application 510. The available services are those which the selected provider has agreed to provide in exchange for direct payment through the healthcare payment system 110 at the listed prices. The service selection module 516 of the mobile application 510 may display a graphical user interface on the mobile device 100 to allow the consumer 112 to select from a list of the available services. The graphical user interface may also display a plurality of payment options for the selected service. The different payment options may be based on whether the consumer 112 decides to pay all cash (e.g., a transfer from a bank account or HSA account), pay with a credit card, or pay a portion from an insurance plan (e.g., PPO). The consumer 112 may select one of the payment options from the list or elect to override the list and manually enter a different price agreed to by the provider 114.

The payment module 518 of the mobile application 510 may display a graphical user interface on the mobile device 100 to prompt the consumer 112 to confirm details associated with the payment (e.g., provider information, payment amount, and funding sources) and allow the provider or provider representative to attest to the accuracy of the information and to authorize the payment. In response to the consumer's authorization, the payment module 518 of the mobile application 510 transmits a payment request to the payment module 526 of the application server 534, which performs the payment transaction as described below.

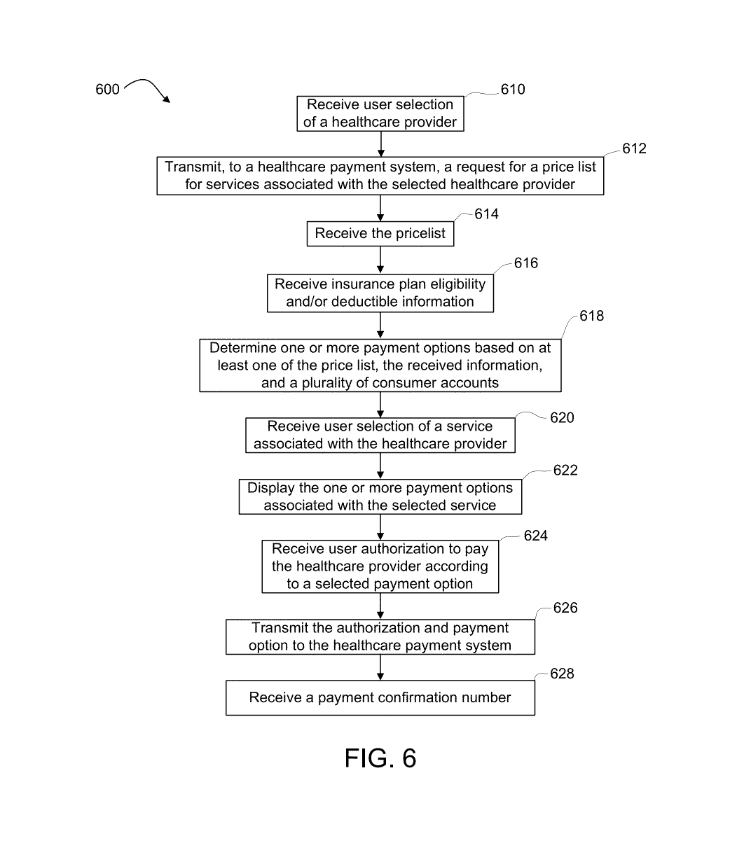

FIG. 6 is a flowchart of a method 600 performed by mobile application 510 of the mobile device 100 to make healthcare payments according to one embodiment. The method 600 includes receiving 610 user selection of a healthcare provider and transmitting 612, to a healthcare payment system, a request for a price list for services associated with the selected healthcare provider. The method 600 further includes receiving 614 the pricelist, receiving 616 insurance plan eligibility and/or deductible information, and determining 618 one or more payment options based on at least one of the price list, the received information, and a plurality of consumer accounts. For example, the mobile application 510 may determine a plurality of different prices available to the consumer 112 based on whether the consumer 112 decides to pay all cash (e.g., a transfer from a bank account or HSA account), pay with a credit card, or pay a portion from an insurance plan (e.g., PPO).

The method 600 also includes receiving 620 user selection of a service associated with the selected healthcare provider, displaying 622 the one or more payment options associated with the selected service, receiving 624 user authorization to pay the healthcare provider according to a selected payment option, and transmitting 626 the authorization and payment option to the healthcare payment system. In response, the method 600 also includes receiving 628 a payment confirmation number from the healthcare payment system.

Returning to FIG. 5, the database server 536 stores information in one or more relational databases. The information may include, for example, consumer information, provider information, insurance company information, account information, transaction information, and other information described herein.

The batch server 538 interfaces with the application server 534 and the database server 536 to process payment requests and other tasks described herein. In this example, the batch server 538 includes an “EDI 835” transaction generator 543 configured to submit electronic remittance advice to the provider 114, an “EDI 837” transaction generator 544 configured to electronically submit a claim to the insurance company 116, an ACH/EFT generator 546 configured to transfer funds between banks 550 (e.g., banks 312, 314, and consumer accounts 310 shown in FIG. 3), and an email generator 548 to generate emails (e.g., including a receipt evidencing payment) that may be sent to the consumer 112 (or other parties) through the email server 542 and/or a text message server (not shown).

The web server 540 provides another interface to the application server 534 of the healthcare payment system 110. The web server 540 hosts the website 118, which is accessible to users 552 through a public network 554. The public network 554 may include, for example, the internet, an intranet, a WAN, an LAN, or another network that is publically accessible. The website 118 may be configured to advertise or provide information about the healthcare payment system 110, provide healthcare information or education, and/or provide communication with the users 552. The users may include, for example, healthcare consumers, healthcare providers, insurance companies, banks, or other parties. For example, the consumer 112 may elect to access the healthcare payment system 110 through either the mobile application 510 or the website 118. As another example, the provider 114 may use the website 118 to identify services and commit to a pricing list for the identified services.

It will be understood by those having skill in the art that many changes may be made to the details of the above-described embodiments without departing from the underlying principles of the invention. The scope of the present invention should, therefore, be determined only by the following claims.

1. A method for providing consumer-driven healthcare payments to providers of healthcare services, the method comprising:
receiving, from a mobile device associated with a consumer of healthcare services, an identification of a selected provider of the healthcare services;
in response to receiving the identification of the selected provider, identifying a price list for one or more healthcare services offered by the provider;
transmitting the identified price list to the mobile device associated with the consumer;
receiving a payment request from the mobile device associated with the consumer, the payment request identifying at least one service selected from the price list and one or more funding sources; and
transferring electronic payment for the selected service from the one or more funding sources to an account associated with the selected provider.

2. The method of claim 1, further comprising:
requesting and receiving insurance plan information from an insurance company associated with the consumer;
transmitting the insurance plan information to the mobile device associated with the consumer; and
transmitting claim encounter data to the insurance company.

3. The method of claim 2, further comprising:
in exchange for transferring the electronic payment and transmitting the claim encounter data to the insurance company, receiving a service fee from the insurance company.

4. The method of claim 2, further comprising:
determining one or more payment options based on at least one of the price list, the received insurance plan information, and information associated with the funding sources; and
transmitting the one or more payment options to the mobile device associated with the consumer.

5. The method of claim 4, wherein the insurance plan information includes at least one of plan eligibility information and deductible information.

6. The method of claim 4, wherein the information associated with the funding sources includes an available amount remaining in a health savings account (HSA).

7. The method of claim 1, further comprising:
after transferring electronic payment to the account associated with the selected provider, transmitting a payment confirmation message to the mobile device associated with the consumer.

8. The method of claim 1, further comprising:
after transferring electronic payment to the account associated with the selected provider, communicating a payment confirmation message to the selected provider.

9. The method of claim 1, wherein the one or more funding sources are selected from a group comprising a bank account associated with the consumer, a health savings account (HSA) associated with the consumer, a health insurance plan associated with the consumer, a credit card associated with the consumer, a debit card associated with the consumer, and an electronic payment service associated with the consumer.

10. The method of claim 9, wherein the payment request further identifies respective portions of the price to draw from two or more of the funding sources as part of the electronic payment transferred to the account associated with the selected provider.

11. The method of claim 1, further comprising:
in exchange for using the mobile device to authorize direct payment of the selected provider through the payment request, transferring a reward to an account associated with the consumer.

12. A healthcare payment system comprising:
one or more servers configured to:
receive, from a mobile device associated with a consumer of healthcare services, an identification of a selected provider of the healthcare services;
in response to receiving the identification of the selected provider, identify a price list for one or more healthcare services offered by the provider;
transmit the identified price list to the mobile device associated with the consumer
receive a payment request from the mobile device associated with the consumer, the payment request identifying at least one service selected from the price list and one or more funding sources; and
transfer electronic payment for the selected service from the one or more funding sources to an account associated with the selected provider.

13. The healthcare payment system of claim 12, the one or more servers further configured to:
request and receive insurance plan information from an insurance company associated with the consumer;
transmit the insurance plan information to the mobile device associated with the consumer; and
transmit claim encounter data to the insurance company.

14. The healthcare payment system of claim 13, the one or more servers further configured to:
in exchange for transferring the electronic payment and transmitting the claim encounter data to the insurance company, receive a service fee from the insurance company.

15. The healthcare payment system of claim 13, the one or more servers further configured to:
determine one or more payment options based on at least one of the price list, the received insurance plan information, and information associated with the funding sources; and
transmit the one or more payment options to the mobile device associated with the consumer.

16. The healthcare payment system of claim 15, wherein the insurance plan information includes at least one of plan eligibility information and deductible information.

17. The healthcare payment system of claim 15, wherein the information associated with the funding sources includes an available amount remaining in a health savings account (HSA).

18. The healthcare payment system of claim 12, the one or more servers further configured to:
after transferring electronic payment to the account associated with the selected provider, transmit a payment confirmation message to the mobile device associated with the consumer.

19. The healthcare payment system of claim 12, the one or more servers further configured to:
after transferring electronic payment to the account associated with the selected provider, communicate a payment confirmation message to the selected provider.

20. The healthcare payment system of claim 12, wherein the one or more funding sources are selected from a group comprising a bank account associated with the consumer, a health savings account (HSA) associated with the consumer, a health insurance plan associated with the consumer, a credit card associated with the consumer, a debit card associated with the consumer, and an electronic payment service associated with the consumer.

21. The healthcare payment system of claim 20, wherein the payment request further identifies respective portions of the price to draw from two or more of the funding sources as part of the electronic payment transferred to the account associated with the selected provider.

22. The healthcare payment system of claim 12, the one or more servers further configured to:
in exchange for using the mobile device to authorize direct payment of the selected provider through the payment request, transfer a reward to an account associated with the consumer.

23. A non-transitory computer-readable storage medium comprising instructions to cause a machine to perform a method for providing healthcare payments to providers of healthcare services, the method comprising:
receiving, from a mobile device associated with a consumer of healthcare services, an identification of a selected provider of the healthcare services;
in response to receiving the identification of the selected provider, identifying a price list for one or more healthcare services offered by the provider;
transmitting the identified price list to the mobile device associated with the consumer;
receiving a payment request from the mobile device associated with the consumer, the payment request identifying at least one service selected from the price list and one or more funding sources; and
transferring electronic payment for the selected service from the one or more funding sources to an account associated with the selected provider.

24. A non-transitory computer-readable storage medium comprising instructions to cause a mobile device to perform a method for providing healthcare payments to providers of healthcare services, the mobile device associated with a consumer of the healthcare services, the method comprising:
receiving, at the mobile device associated with the consumer, a user selection of a provider of the healthcare services;
transmitting, from the mobile device associated with the consumer to a healthcare payment system, an identification of the selected provider;
receiving, at the mobile device associated with the consumer, a user selection of a healthcare service provided by the selected provider, the selected healthcare service associated with a price;
receiving, at the mobile device associated with the consumer, an authorization to pay the price associated with the selected healthcare service;
in response to the authorization, transmitting a payment request from the mobile device associated with the consumer to a healthcare payment system, wherein the payment request identifies the price for the selected service and one or more funding sources; and
receiving, from the healthcare payment system, a payment confirmation message indicating an electronic payment for the selected service from the one or more funding sources to an account associated with the selected provider.

25. The non-transitory computer-readable storage medium of claim 24, wherein the one or more funding sources are selected from a group comprising a bank account associated with the consumer, a health savings account (HSA) associated with the consumer, a health insurance plan associated with the consumer, a credit card associated with the consumer, a debit card associated with the consumer, and an electronic payment service associated with the consumer.

26. The non-transitory computer-readable storage medium of claim 25, wherein the payment request further identifies respective portions of the price to draw from two or more of the funding sources as part of the electronic payment transferred to the account associated with the selected provider.

27. The non-transitory computer-readable storage medium of claim 24, the further comprising:
in exchange for using the mobile device to authorize direct payment of the selected provider through the payment request, receiving notification of a reward to an account associated with the consumer.

28. The non-transitory computer-readable storage medium of claim 24, the method further comprising:
receiving, at the mobile device associated with the consumer, a price list for one or more services offered by the provider.

29. The non-transitory computer-readable storage medium of claim 28, the method further comprising:
receiving, at the mobile device associated with the consumer, insurance plan information;
determining one or more payment options based on at least one of the price list, the received insurance plan information, and information associated with the funding sources; and
displaying the one or more payment options in a user interface of the mobile device associated with the consumer.

30. The non-transitory computer-readable storage medium of claim 29, wherein the insurance plan information includes at least one of plan eligibility information and deductible information.

31. The non-transitory computer-readable storage medium of claim 29, wherein the information associated with the funding sources includes an available amount remaining in a health savings account (HSA).
